(19) United States
(12) Patent Application Publication
(10) Pub. No.: US 2025/0367764 A1
(43) Pub. Date: Dec. 4, 2025

(54) PROCESS FOR MANUFACTURING PARTS BY LASER CUTTING METALLIC-GLASS STRIPS

(71) Applicant: PATEK PHILIPPE SA GENEVE, Genève (CH)

(72) Inventors: Coline JIGUET, Plan-les-Ouates (CH); Laura WAGNIERES, Plan-les-Ouates (CH)

(21) Appl. No.: 18/869,748

(22) PCT Filed: May 31, 2023
(86) PCT No.: PCT/EP2023/064478

§ 371 Date: Nov. 26, 2024

(30) Foreign Application Priority Data
May 31, 2022 (EP) 22176379.0

(51) Int. Cl. B23K 26/38; B23K 26/06; B23K 26/0622; B23K 26/082; B23K 103/00; B23K 103/08; G04D 3/00

(52) U.S. Cl. CPC B23K 26/38; B23K 26/0624; B23K 26/0643; B23K 26/082; G04D 3/0069; B23K 2103/08; B23K 2103/54

(57) ABSTRACT

Disclosed is a process for cutting a metallic-glass strip, comprising applying to the strip a pulsed laser beam of wavelength shorter than or equal to 555 nanometers, the pulsed laser beam being formed of a succession of pulses each having a duration shorter than 10 picoseconds, and advantageously shorter than 1 picosecond, the crystallization temperature of the metallic glass being below 500° C., and the light energy of the laser beam incident on the strip being comprised between 1 and 10 microjoules per pulse.

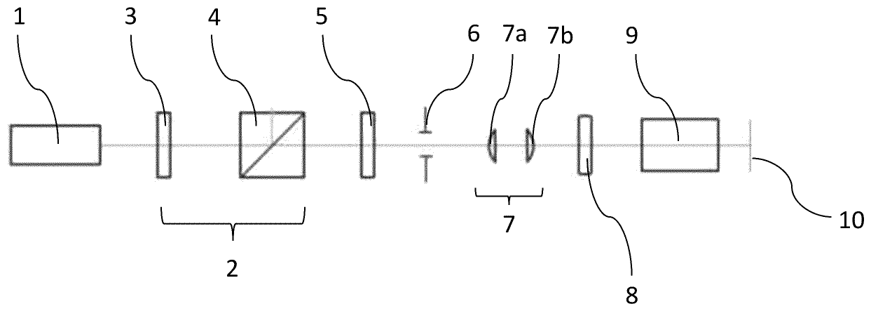

### TECHNICAL FIELD

Generally, the present invention relates to a process for laser cutting metallic-glass strips, and more particularly it relates to a process for producing parts or blanks by cutting metallic-glass strips with the aid of a pulsed laser beam. In particular, the present invention relates to such a process which is suitable for producing parts or blanks of watchmaking micromechanical parts in metallic glass.

### PRIOR ART

The metallic glasses or amorphous metals are metallic alloys, the atomic structure of which is not crystalline. These alloys are generally produced by cooling which is sufficiently rapid to prevent the formation of crystalline structures. The amorphous structure of the constituent material of these alloys provides them with mechanical properties which are radically different from those of the crystalline metals. In general, the metallic glasses have mechanical, physical and chemical properties capable of promising applications. Indeed, the parts made of metallic glass (bulk metallic glass; BMG) generally have an elastic limit, an endurance limit, a tensile strength, a corrosion resistance, a hardness and a wear resistance, all of which are higher than those of parts made of crystalline metal. These differences make metallic glasses choice materials for producing small parts in the field of watchmaking, in particular. The wear resistance of the metallic glasses and their capacity to store a significant quantity of energy through elastic deformation, especially, are two extremely attractive characteristics.

However, the metallic glasses are difficult to work with. Indeed, they are fragile materials, the range of plastic deformation of which is limited or, indeed, sometimes non-existent. Thus, these materials have a tendency to fracture as soon as their limit of elasticity is exceeded. Indeed, since they do not have a crystalline structure, the metallic glasses do not have dislocations either. Now, it is these dislocations which, by moving, propagate plastic deformations and provide the metal with its ductility. On the other hand, the metallic glasses have crystallization and melting temperatures which are relatively low. When working with these glasses, it is therefore important to limit the heat inputs so as not to risk heating them up to their crystallization temperature, otherwise their mechanical properties will be altered. Finally, the low thermal conductivity of the metallic glasses makes it very difficult to cool them “to their core” rapidly. It will be understood from the above that the machining methods traditionally used in watchmaking are not suitable for these new materials.

Machining amorphous metals is a recent problem, with a large number of discoveries concerning their production having been made in the 1990s. To date, there are therefore no established protocols guaranteeing non-crystallization of the shaped parts. Furthermore, since this family of materials is vast, there are major disparities in the properties.

A laser is a generator of monochromatic and coherent electromagnetic radiation. The laser cutting of strips, which is referred to in the preamble, is a machining process which appeared in the 1960s. Laser cutting makes it possible to shape parts from materials of various kinds. This process consists of cutting the material using a large quantity of energy produced by a laser and concentrated on a very small surface. Focusing the laser beam makes it possible to raise the temperature of a small zone of material up to the point of vaporization. The Heat Affected Zone (HAZ) of the laser beam is relatively small, which explains the small amount of deformation suffered by the cut parts. The main disadvantages of laser cutting are the formation of zones where the quality of the machined material is altered by the heat, as well as the formation of burrs at the edge of the cut.

Today, pulsed lasers exist, which are capable of generating series of pulses of extremely short durations with a high instantaneous power. This makes it possible to restrict the production of heat to extremely short intervals of time. The possibility that the machined material cools between each pulse makes it possible to limit the temperature rise compared with a continuously operating laser. This particularity can be an advantage when cutting metallic glasses since it could potentially make it possible to keep the temperature of the amorphous material below its crystallization temperature.

It is worth just mentioning again that the implementation of certain known laser cutting processes is accompanied by the use of an assist gas. This gas can be reactive in nature (for example, oxygen) and can be used with the objective of increasing the removal of material taking place on the surface to be machined. Alternatively, the gas can be non-reactive in nature (for example, argon). A non-reactive gas will in principle make it possible to obtain a better cutting quality, and it will in addition contribute to the removal of the material particles.

Despite the advances which have been made, the person skilled in the art still does not have, to date, a process for manufacturing parts by cutting metallic-glass strips with the aid of a pulsed laser beam, which guarantees the non-crystallization of the cut metallic glass.

The publication WO 2022/234155 describes a process for cutting metallic glasses having:
a critical diameter (Dc) less than 5 millimeters, preferably less than 3 millimeters, and/or
a difference (Δx) between the crystallization temperature (Tx) and the glass transition temperature (Tg) less than 60° C., and/or
a quotient (ΔTx/(Tl−Tg)) of the difference (ΔTx) between the crystallization temperature (Tx) and the glass transition temperature (Tg) and of the difference between the liquidus temperature (Tl) and the glass transition temperature (Tg) less than 0.12, preferably less than 0.1.

The amorphous metallic alloys described in the publication WO 2022/234155 are nickel-based. These amorphous metallic alloys have crystallization temperatures above 650° C. This document does not provide any information on the behavior of amorphous metallic alloys having low crystallization temperatures, in particular less than 650° C.

### DISCLOSURE OF THE INVENTION

One object of the present invention is to remedy the disadvantages of the prior art which have just been explained. The present invention achieves this object as well as others by providing a process for cutting a metallic-glass strip comprising applying to the strip a pulsed laser beam of wavelength shorter than or equal to 555 nanometers, the pulsed laser being formed of a succession of pulses each having a duration shorter than 10 picoseconds, and advantageously shorter than 1 picosecond.

In accordance with the invention, the metallic glass has a crystallization temperature below 500° C., and the light energy of the laser beam incident on the strip is comprised between 1 and 10 microjoules per pulse.

The present invention also relates to a process for cutting a metallic-glass strip, said process comprising the following steps:
a) providing equipment comprising at least one laser arranged to produce a pulsed laser beam of wavelength shorter than or equal to 555 nanometers, the pulsed laser beam being formed of a succession of pulses each having a duration shorter than 10 picoseconds, and advantageously shorter than 1 picosecond, and an attenuation module of the laser beam arranged to be able to adjust the quantity of light energy of the incident laser beam;
b) providing a metallic-glass sample to be cut;
c) adjusting the attenuation module such that the light energy of the laser beam incident on the strip is comprised between 1 and 10 microjoules per pulse if the metallic glass to be cut has a crystallization temperature below 500° C., and such that the light energy of the laser beam incident on the strip is comprised between 15 and 80 microjoules per pulse if the metallic glass to be cut has a crystallization temperature above 500° C.; and
d) cutting the strip by applying to said metallic-glass sample the laser beam, the light energy of which has been adjusted according to step c), by implementing the cutting process as defined above if the metallic glass has a crystallization temperature below 500° C., or by applying to the metallic-glass sample said laser beam, the light energy of which is comprised between 15 and 80 microjoules per pulse, if the metallic glass has a crystallization temperature above 500° C.

### BRIEF DESCRIPTION OF THE DRAWINGS

Other characteristics and advantages of the present invention will appear on reading the following description, which is provided solely by way of a non-limiting example, and with reference to the appended drawing which schematically illustrates, by way of example, a laser system capable of being used to implement the processes of the invention.

### EMBODIMENTS OF THE INVENTION

A process for cutting a metallic-glass strip according to the invention comprises applying, to the strip, a pulsed laser beam of wavelength shorter than or equal to 555 nanometers, the pulsed laser beam being formed of a succession of pulses each having a duration shorter than 10 picoseconds, and advantageously shorter than 1 picosecond, said metallic glass having a crystallization temperature below 500° C., and the light energy of the laser beam incident on the strip being comprised between 1 and 10 microjoules per pulse.

This process for cutting a metallic-glass strip having a crystallization temperature below 500° C. can be implemented in a more global process for cutting a metallic-glass strip using equipment which makes it possible to cut a metallic-glass strip whatever the crystallization temperature of the metallic glass to be cut. To this end, this process comprises the following steps:
a) providing equipment comprising at least one laser arranged to produce a pulsed laser beam of wavelength shorter than or equal to 555 nanometers, the pulsed laser beam being formed of a succession of pulses each having a duration shorter than 10 picoseconds, and advantageously shorter than 1 picosecond, and an attenuation module of the laser beam arranged to be able to adjust the quantity of light energy of the incident laser beam;
b) providing a metallic-glass sample to be cut;
c) adjusting the attenuation module such that the light energy of the laser beam incident on the strip is comprised between 1 and 10 microjoules per pulse if the metallic glass to be cut has a crystallization temperature below 500° C., and such that the light energy of the laser beam incident on the strip is comprised between 15 and 80 microjoules per pulse if the metallic glass to be cut has a crystallization temperature above 500° C.; and
d) cutting the strip by applying to said metallic-glass sample the laser beam, the light energy of which has been adjusted according to step c), by implementing the cutting process as defined above if the metallic glass has a crystallization temperature below 500° C., or by applying to the metallic-glass sample said laser beam, the light energy of which is comprised between 15 and 80 microjoules per pulse, if the metallic glass has a crystallization temperature above 500° C.

The central element of the equipment which makes it possible to implement the processes of the invention is of course the laser. The appended FIG. schematically illustrates, by way of example, a laser system capable of being used to implement the processes of the invention. In this figure, reference numeral 1 denotes a femtosecond laser, reference numeral 2 denotes an attenuation module for the laser beam, which comprises a rotating half-wave delay strip 3 and a polarized semi-reflecting mirror 4, reference numeral 5 denotes a quarter-wave strip which makes it possible to change the linear polarization of the laser beam into circular polarization, reference numeral 6 denotes an opening diaphragm (or iris), reference numeral 7 denotes an afocal system which is made up of a set of associated optical elements 7a, 7b in a telescope configuration, reference numeral 8 denotes a device for measuring the light power, reference numeral 9 denotes a telecentric objective (or optical deviation system) which makes it possible to control the scanning of the work plane by the laser beam. Finally, reference numeral 10 denotes the metallic-glass strip which has to be cut with the aid of the processes of the invention.

The laser which has the reference numeral 1 is an ultra, or quasi-ultra, short pulse laser, the duration of the laser pulses being between 100 femtoseconds and 10 picoseconds, and preferably being between 100 femtoseconds and 1 picosecond. The repetition rate of the laser pulses (the cadence) is comprised between 5 kHz and 1 MHz, advantageously between 5 kHz and 30 kHz, preferably between 5 kHz and 25 kHz, typically 5, 10, 15, 20, 25 kHz.

Preferably, when the metallic glass to be cut has a crystallization temperature below 500° C., the light energy of the laser beam incident on the strip is comprised between 1 and 10 microjoules per pulse, and the repetition rate of the laser pulses (the cadence) is comprised between 5 kHz and 30 kHz, preferably between 5 kHz and 25 kHz.

The wavelength of the laser beam is shorter than or equal to 555 nanometers. According to a first variant, the light emitted by the laser 1 is green, its wavelength being comprised between 490 and 555 nanometers. It can, for example, be equal to 513 or 515 nanometers. According to a second variant, the laser 1 emits in a blue-violet range, its wavelength being comprised between 380 and 490 nanometers, preferably comprised between 405 and 450 nanometers. It can, for example, be equal to 405, 445, 447 or 450 nanometers. According to a third variant, the laser 1 emits in the ultraviolet range, its wavelength being comprised between 330 and 380 nanometers. It can, for example, be equal to 343 nanometers. It will be noted that the wavelengths of 515 nm (green) and of 343 nm (ultraviolet) cited by way of example can both be produced from the same laser. Indeed, these two wavelengths can be obtained respectively by doubling and by tripling the fundamental frequency of a same laser, the fundamental frequency of the laser corresponding to a wavelength of 1030 nm.

The attenuation module (having the reference numeral 2) makes it possible to adjust the quantity of energy contained in the pulses produced by the laser system of the appended figure. At the exit of the laser 1, the intensity of the beam is maximal. The beam then passes through an attenuation module 2 which makes it possible to attenuate and to adjust its intensity or, in other words, to attenuate and adjust the energy of each pulse of the beam. The attenuation module 2 makes it possible, for example, to adjust the energy of the pulses in a range comprised between 0 and 150 microjoules. It will be understood that the energy contained in the laser pulses is responsible for increasing the temperature of the metallic-glass strip. In order to avoid the crystallization of the metallic glass, it is preferable to keep the temperature of the strip below the crystallization temperature. Under these conditions, the lower the crystallization temperature of the metallic glass, the more the energy of the laser beam would have to be attenuated. Thus, when the crystallization temperature of the metallic glass of the strip 10 is below 500° C., a first embodiment of the process of the invention will preferably be used, according to which the energy of the pulses of the laser beam incident on the strip is comprised between 1 and 10 microjoules, corresponding to a fluence less than approximately 8 J/cm² (with a laser of wavelength 515 nm, pulse duration of 230 fs, spot size of 13 μm, frequency 25 kHz and scanning speed of 5 mm/s). An energy comprised between 10 and 14 microjoules per pulse could also be used. To this end and advantageously, the attenuation module 2 has previously been adjusted according to step c) of the process as a function of the crystallization temperature of the metallic glass to be cut. By way of example, the metallic glass cut using the first embodiment could advantageously be an alloy TibalanceZr35.0Cu17.0S8.0 (atomic percentages) such as Medalium T1 which is distributed by Amorphous Metal Solutions GmbH, an alloy ZrbalanceCu17.9Ni14.6Al10.0Ti5.0 (atomic percentages) such as Medalium Z2 which is distributed by Amorphous Metal Solutions GmbH, or an alloy Zr59.3Cu28.8Al10.4Nb1.5 (atomic percentages) such as AMZ4 which is distributed by Heraeus Group, all three of which have a crystallization temperature below 480° C. By contrast, when the crystallization temperature of the metallic glass of the strip 10 is above 500° C., a second embodiment of the process will preferably be used, according to which the energy of the pulses of the laser beam incident on the strip is comprised between 15 and 80 microjoules. To this end and advantageously, the attenuation module 2 has previously been adjusted according to step c) of the process as a function of the crystallization temperature of the metallic glass to be cut. By way of example, the metallic glass cut using the second embodiment could advantageously be an alloy NibalanceNb38.0 (atomic percentage) such as Medalium N1 which is distributed by Amorphous Metal Solutions GmbH or an alloy Ni(57-67)Nb(28-38)Zr(0-10) (atomic percentages) such as the Vulkalloys® which are distributed by Vulkam, in particular the Ni1, which both have a crystallization temperature above 600° C.

At the exit of the laser 1, the beam is polarized linearly. A disadvantage of having a linearly polarized beam is that the effectiveness of the ablation can depend on the angle between the direction of advancement of the point of incidence and the direction of polarization. The quarter-wave strip (having the reference numeral 5 in the appended figure) makes it possible to change the linear polarization of the beam into a circular polarization, and to thus eliminate this undesirable effect.

The reference numeral 7 of the appended figure denotes an afocal system comprising a divergent lens 7a and a convergent lens 7b, which are associated, in a telescope configuration. The telescope configuration makes it possible to enlarge the size of the beam emerging from the iris 6.

The strip 10, which is intended to be cut using the process of the invention, is a thin strip. Its maximum thickness does not exceed 1 millimeter. It is preferably even less than 500 microns. Furthermore, it is worth specifying that the strip having the reference numeral 10 in the appended figure is not necessarily a strip of constant thickness. It can just as well be a strip, the thickness of which varies from one place to another on the strip.

The metallic-glass sample to be cut provided in step b) is generally in the form of a plate.

The metallic glasses used in the present invention preferably have a critical diameter (Dc) greater than or equal to 5 mm. The metallic-glass bars obtained following molding are cut into slices (cross-section of the cylinder, preferably located toward the middle of the bar) of thickness comprised between 1 and 10 millimeters. The slices obtained are analyzed by X-ray diffraction in order to determine whether they have an amorphous or partially crystalline structure. The critical diameter is then determined as being the maximum diameter for which the structure is amorphous. This means that the critical diameter can be defined as the diameter above which an X-ray diffraction analysis clearly reveals crystallinity peaks. Such an evaluation of the amorphous character of a metallic alloy is detailed in the article by Cheung and al., 2007 “Thermal and mechanical properties of Cu—Zr—Al bulk metallic glasses” doi:10.1016/j.jallcom.2006.08.109).

The metallic-glass strip is cut by ablation and therefore progressive hollowing-out of a groove. The width of the groove is at least as large as the diameter of the point of incidence (or spot) of the laser beam on the surface of the strip 10. The optic of the laser system is preferably adjusted so as to focus the laser beam on the surface of the strip. The diameter of the point of incidence therefore corresponds to the diameter of the beam at its focal point. As the strip is thin and the opening angle of the laser beam is also small, it is not necessary to change the focal length during the process to take account of the depth of the groove.

By convention, in the present application, the size of the laser beam is measured by measuring its width (its diameter) at 1/E² (that is to say, approximately at 13.5%) of the intensity maximum. It is known that the light intensity (power) is maximum on the axis of the beam and that it decreases as one moves away from this axis. The diameter of the point of incidence of the laser beam on the strip (measured according to this convention) is preferably comprised between 5 and 15 microns. Based on the same convention, the energy density (fluence) of the incident laser pulses can, in addition, be calculated by dividing the energy of a pulse by the surface area of the point of incidence.

The width of the groove in the strip is preferably comprised between 5 and 25 microns. According to an advantageous variant, the laser beam is focused on a diameter which is smaller than the width of the groove to be obtained, and it is moved circularly by a rotating optic (called a trepanation head).

In addition, it will be understood that various modifications and/or improvements which are obvious to a person skilled in the art can be made to the embodiments which are the subject-matter of the present description without departing from the scope of the present invention defined by the appended claims.

1. A process for cutting a metallic-glass strip, the method comprising:
applying a pulsed laser beam of wavelength shorter than or equal to 555 nanometers to the metallic-glass strip, the pulsed laser beam being formed of a succession of pulses each having a duration shorter than 10
wherein metallic glass of the metallic-glass strip has a crystallization temperature below 500° C., and
light energy of the laser beam incident on the strip is comprised between 1 and 10 microjoules per pulse.

2. The process for cutting the metallic-glass strip, further comprising:
providing equipment comprising
at least one laser configured to produce the pulsed laser beam of wavelength shorter than or equal to 555 nanometers, and
an attenuator of the laser beam configured to adjust a quantity of the light energy of the incident laser beam;
providing a metallic-glass sample to be cut;
adjusting the attenuator such that the light energy of the laser beam incident on the strip is comprised between 1 and 10 microjoules per pulse when the crystallization temperature of the metallic glass of the metallic-glass sample to be cut is below 500° C., and such that the light energy of the laser beam incident on the strip is comprised between 15 and 80 microjoules per pulse when the crystallization temperature of the metallic glass of the metallic-glass sample to be cut is above 500° C.; and
cutting the metallic-glass strip by applying the laser beam to the metallic-glass sample, the light energy of which has been adjusted by the adjusting the attentuator, by one of: (i) the applying the pulsed laser beam of wavelength shorter than or equal to 555 nanometers to the metallic-glass strip when the metallic glass of the metallic-glass strip has the crystallization temperature below 500° C., and (ii) applying said laser beam to the metallic-glass sample, the light energy of which is comprised between 15 and 80 microjoules per pulse, when the metallic glass of the metallic-glass strip has the crystallization temperature above 500° C.

3. The cutting process according to claim 1, wherein the wavelength is comprised between 490 and 555 nanometers.

4. The cutting process according to claim 1, wherein the wavelength is comprised between 380 and 490 nanometers.

5. The cutting process according to claim 1, wherein the wavelength is shorter than 380 nanometers.

6. The process according to claim 2, wherein the attenuator comprises a rotating half-wave delay strip and a polarized semi-reflecting mirror.

7. The cutting process according to claim 1, wherein the laser beam is polarized circularly.

8. The process according to claim 2, wherein the laser beam produced by the laser is polarized linearly and the equipment comprises a quarter-wave strip configured to change the linear polarization of the laser beam into circular polarization.

9. The cutting process according to claim 2, wherein the crystallization temperature of the metallic glass is above 600° C.

10. The cutting process according to claim 9, wherein the metallic glass is an alloy NiNb38.0 (atomic percentage) or an alloy Ni(57-67)Nb(28-38)Zr(0-10) (atomic percentages).

11. The cutting process according to claim 1, wherein the crystallization temperature of the metallic glass is below 480° C., the metallic glass being selected from an alloy TiZr35.0Cu17.0S8.0 (atomic percentages), an alloy ZrCu17.9Ni14.6A110.0Ti5.0 (atomic percentages), and an alloy Zr59.3Cu28.8A110.4Nb1.5 (atomic percentages).

12. The cutting process according to claim 1, wherein the repetition rate of the pulsed laser beam is comprised between 5 and 30 kHz.

13. The cutting process according to claim 1, wherein the metallic-glass strip has a thickness which does not exceed 1 millimeter.

14. The cutting process according to claim 1, wherein the metallic-glass strip has a thickness which is not constant but varies from one location on the metallic-glass strip to another location on the metallic-glass strip.

15. The cutting process according to claim 1, wherein the applying the pulsed laser beam on the strip hollows out at least one groove having a width comprised between 5 and 25 microns.

16. The cutting process according to claim 1, wherein the diameter of the laser beam incident on the plate (spot size) is comprised between 5 and 15 microns at the focusing point.

17. The cutting process according to claim 1, wherein the laser beam is focused on a diameter smaller than the width of the groove to be obtained, and the laser beam is moved circularly by a rotating optic.

18. A watchmaking micromechanical part obtained by implementing the process according to claim 1.

19. The cutting process according to claim 1, wherein the wavelength is comprised between 405 and 450 nanometers.

20. The cutting process according to claim 5, wherein the wavelength is longer than 330 nanometers.
